(19) United States
(12) Patent Application Publication
(10) Pub. No.: US 2007/0120865 A1
(43) Pub. Date: May 31, 2007

(54) Applying rendering context in a multi-threaded environment

(76) Inventor: Kam L. Ng, Bellevue, WA (US)

Correspondence Address: Rochelle Lieberman;Lieberman & Brandsdorfer, LLC, 12221 McDonald Chapel Drive, Gaithersburg, MD, 20878-2252, US

(21) Appl. No.: 11/288,634

(22) Filed: Nov. 29, 2005

(51) Int. Cl. G09G 5/00

(52) U.S. Cl. 345/582

(57) ABSTRACT

A method and system are provided for managing a multi-threaded process invoking an OpenGL32 command to an OpenGL32 library. Each command requires rendering context as a parameter for access to the library. A manager is provided in conjunction with a table to store rendering context. Each rendering context in the table is assigned an identifier. A thread issuing an OpenGL32 command with an identifier associated with rendering context is passed through to the OpenGL32 library. Similarly, for an OpenGL32 command presented to the manager without an identifier associated therewith, rendering context is created and stored in the table with an associated identifier.

### BACKGROUND OF THE INVENTION

1. Technical Field

This invention relates to managing rendering context for a thread issuing an OpenGL32 command. More specifically, a mechanism is employed to manage rendering context within an OpenGL32 command utilizing multiple threads in a single process.

2. Description Of The Prior Art

OpenGL32 is a library of graphics routines available on a wide variety of hardware platforms and operating systems, including Windows 95, Windows NT, OS/2, and Digital's Open VMS. OpenGL32 is more of a renderer than a modeler. Even though you can draw points, lines and polygons using OpenGL32, combining these basic shapes to build the required 3D image remains a function of the application. A subset of OpenGL32 includes, but is not limited to, the following commands: wglCreateContext( ), wglDeleteContext( ), and wglMakeCurrent( ) used in the Microsoft operating systems to allow users to set up or configure rendering context for graphics. Rendering context for use of the OpenGL32 command is required prior to accessing the OpenGL32 library for a graphics command.

Each rendering context is limited to a single thread. FIG. 1 is a block diagram (10) illustrating the elements involved with invoking the OpenGL32 command. A single thread (12) with rendering context issues the OpenGL32 command (14) to an OpenGL32 library (16) of executable functions or data. In one embodiment, the library (16) may be in the form of a dynamically linked library. Only the thread which has rendering context can call an OpenGL32 command. Without modifying the system to accommodate multi-threaded tasking of OpenGL32 commands, programmable instructions invoking multi-threading of associated rendering contexts fail.

One prior art solution for accommodating multi-threaded instructions with the OpenGL32 command is shown in FIG. 2, which is a block diagram (20) of a multi-threaded model. As shown, there are two threads (22) and (24). Both of these threads (22) and (24) require rendering context to invoke an OpenGL32 command. A mutual exclusion object (26), a program object that allows multiple program threads to share the same resource, is employed to manage availability of a rendering context resource when more than one thread within a process requires access to the rendering context. A first thread (22) which has the rendering context calls the OpenGL32 command to access the OpenGL32 library (28). When the first thread (22) has concluded its requirement for the rendering context, the first thread releases the resource and updates the mutual exclusion object. If a second thread (24) in the process also requires but does not have control of the rendering context, it prompts the mutual exclusion object (26) to determine if the rendering context is held by another thread. The second thread (24) waits for the mutual exclusion object to release the rendering context if the first thread (22) has not concluded and released the rendering context. Once the rendering context becomes available, the second thread (24) can proceed with calling the OpenGL32 command to access the library (28). If neither of the threads (22) and (24) holds the rendering context, one of the requesting threads is granted a mutual exclusion object on the rendering context and calls the OpenGL32 command to access the library (28). As shown, the use of the mutual exclusion object is implemented to accommodate and manage program code that supports more than one thread in a process requiring access to an object that can only be held by a single thread at a time. However, the drawback of this solution is the limitation to accommodate only one thread at a time to access the rendering context. Accordingly, the limitation of utilizing one thread at a time does not take advantage of the power of multi-threading processing.

Therefore, there is a need for a method and apparatus that supports multi-threaded processing of accessing rendering context while accessing an OpenGL32 library.

### SUMMARY OF THE INVENTION

This invention comprises a method and system for managing requests for rendering context from multiple threads in a single process.

In one aspect of the invention, a method is provided for managing multithreaded requests for rendering context. An OpenGL32 command for rendering context is received from a requesting thread. In response to receipt of the virtual command accompanied by an identifier, a table is searched for the rendering context to serve the command. The identifier is associated with the rendering context. In response to presence of the rendering context in the table, the command is forwarded to a library.

In another aspect of the invention, a computer system is provided with a context thread manager adapted to receive an OpenGL32 command from a thread in a multi-threaded process. A table in communication with the manager stores rendering context associated with an identifier. The manager forwards the OpenGL32 command with the rendering context to a library in response to presence of the rendering context in the table.

In yet another aspect of the invention, an article is provided with a computer-readable medium. Means in the medium are provided for receiving an open command for rendering context from a requesting thread. Means in the medium are also provided for storing the rendering context to serve the command responsive to receipt of an identifier with the command. The identifier is associated with the rendering context. In addition, means in the medium are provided for forwarding the command with the rendering context to a library responsive to presence of the rendering context in the table.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a prior art block diagram of a single threaded model for managing rendering context.

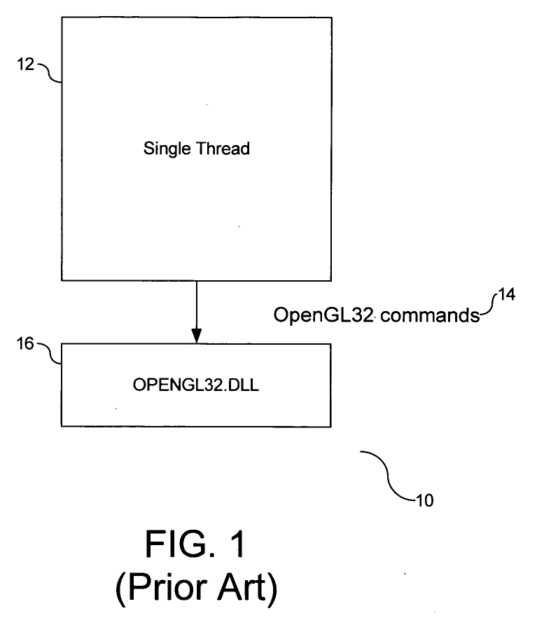

FIG. 2 is a prior art block diagram of a multi-threaded model for managing rendering context.

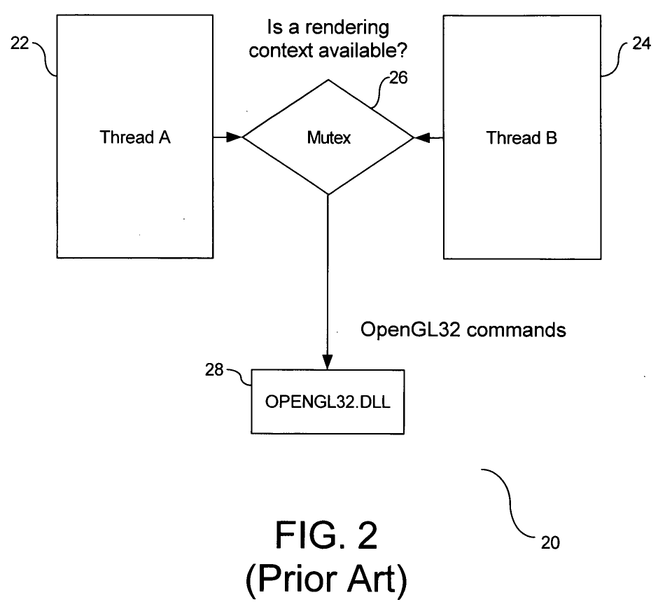

FIG. 3 is a block diagram of a multi-threaded process in communication with a rendering context manager.

FIG. 4 is a flow chart demonstrating receipt of an OpenGL32 command by a rendering context manager according to the preferred embodiment of this invention, and is suggested for printing on the first page of the issued patent.

FIG. 5 is a block diagram of the manager embedded within memory of a server.

### DESCRIPTION OF THE PREFERRED EMBODIMENT

### Overview

Rendering context is a required parameter for completing an OpenGL32 command issued to an OpenGL32 library. A manager is implemented that controls access to rendering context in a multi-threaded process to support access to an OpenGL32 library. The manager is in communication with a table that stores rendering context created in response to prior OpenGL32 commands. An identifier is assigned to each rendering context stored in the table. Since only a single thread that has rendering context can call the OpenGL32 command, the manager functions to direct rendering context to one or more calling threads. Similarly, the manager functions as a conduit to the OpenGL32 library for threads in possession of rendering context or for threads requiring rendering context that are not stored in the table.

### Technical Details

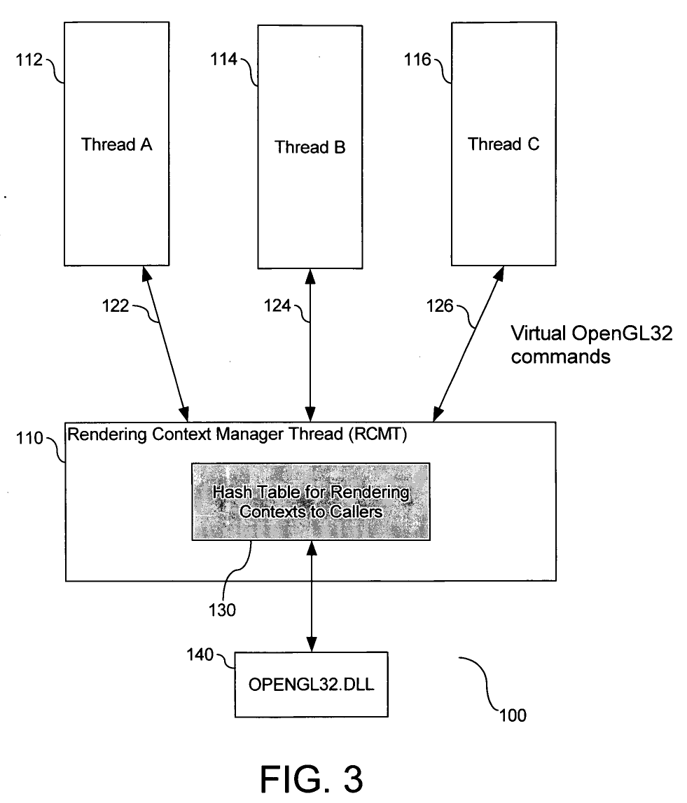

A manager is employed to support multi-threaded processing of requests to access rendering context in an OpenGL32 library. FIG. 3 is a block diagram (100) illustrating the elements of the manager (110) and how the manager functions with managing multiple threads within a process that require access to rendering context. As shown, in this example there are three threads (112), (114), and (116) within a single process. The invention is not limited to three threads. In one embodiment, there may be more threads or fewer threads than that shown in FIG. 3. Each of the threads (112), (114), and (116) may issue an OpenGL32 command (122), (124), and (126), respectively, to the manager (110) to request rendering context for access to the OpenGL32 library (140). The commands issued by the threads (112), (114), and (116) to the manager are known as virtual commands since they are directed to the OpenGL32 library (140) via the manager (110) as an intermediary. In a multi-threaded or multi-processing environment, an inter-thread or interprocessor communication is employed to manage sending of OpenGL32 commands to the manager. As shown, the manager (110) is in communication with a table (130) and the OpenGL32 library (140). In one embodiment, the table (130) may be in the form of a hash table. Preferably, the table (130) stores rendering context issued to one or more prior requesting threads. The OpenGL32 library (140) stores the actual OpenGL32 commands that require rendering context as a parameter that has been saved in the table. Accordingly, the manager uses the table (130) to store rendering context and to enable access to the OpenGL32 library (140) by multiple threads in a single process.

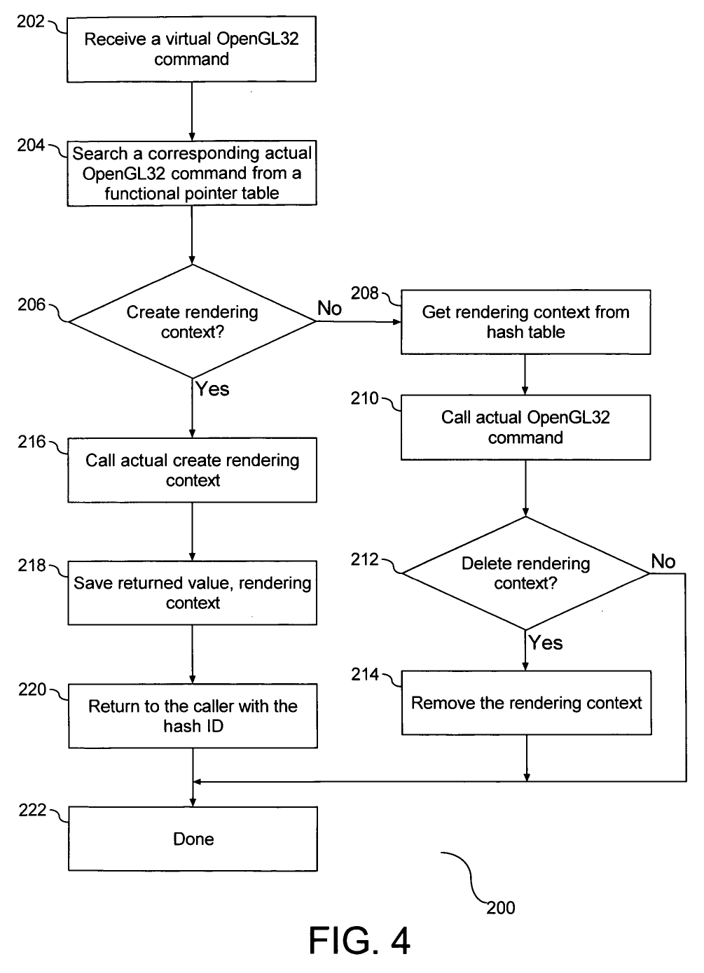

FIG. 4 is a flow chart (200) illustrating a process for managing multi-threaded requests within a single process for rendering context from an OpenGL32 library. The multi-threaded process includes at least two threads. The manager receives a command from one of the threads to delete or use rendering context (202). Upon receipt of the command from step (202), the manager searches a table to locate a corresponding OpenGL32 command (204). In one embodiment, the table is a functional pointer table that consists of an array of functional pointers associated with rendering context related OpenGL32 commands in the OpenGL32 library. A functional pointer is used by the manager to make a call of the OpenGL32 library. Following the search at step (204), a test is conducted to determine if rendering context associated with the command needs to be created (206). In the case of a functional pointer table, a create context command functional pointer is located and utilized to create rendering context. A negative response to the test at step (206) is an indication that the command received at step (202) is a command to delete or use created rendering context stored in a table in communication with the manager. In one embodiment, the table used to store created rendering context is a hash table. The manager locates and obtains the rendering context from the hash table (208) corresponding to the virtual command received at step (202). Thereafter, the manager calls the actual OpenGL32 command (210) by invoking the corresponding functional pointer (204) on behalf of the requesting thread to complete the virtual command call from step (202). Following the actual OpenGL32 command call at step (210), it must be determined if the rendering context associated with the command should be removed from the hash table (212). In one embodiment, rendering context may be removed from the hash table if the virtual command requests to delete the current rendering context. If the response to the test at step (212) is positive, rendering context corresponding to the given identifier as an input parameter of the requesting thread is removed from the table (214) and processing of the OpenGL32 command is completed (222). Similarly, if it is determined at step (212) that the rendering context should remain in the hash table, processing of the OpenGL32 command is completed (222). Accordingly, the hash table is utilized to store rendering context for an OpenGL32 command.

Similarly, if the response to the test at step (206) is positive, this is an indication that the virtual OpenGL32 command received at step (202) is a command to create rendering context to support the virtual command. The manager calls a corresponding functional pointer from a functional pointer table to support creation of rendering context to support the virtual OpenGL32 command (216). Created rendering context is saved in the table (218), an identifier is assigned to the returned rendering context and returned to the calling thread (220), and processing of the OpenGL32 command is completed (222). In one embodiment, the created rendering context is stored in a hash table and the associated identifier is a hash identifier. After the return of an identifier to the requesting thread, the received create rendering context virtual command is complete. If the calling thread wants to use the created rendering context, the calling thread issues another command to request the manager to make an OpenGL32 command (202). The process of the manager is initiated by the arrival of a virtual command at (202). Accordingly, the manager calls a command to create rendering context for a received virtual OpenGL32 command that does not pass an identifier as a parameter for rendering context stored in a table.

The manager directs multiple threads invoking an OpenGL32 command in a single process by use of a table to store created rendering context and to assign a unique identifier to each rendering context stored in the table. A thread passing an identifier assigned to rendering context stored in the table to the manager as a parameter of the command is processed to the OpenGL32 library. Similarly, the manager may create rendering context for an OpenGL32 command without an identifier assigned to rendering context. The table and the assigned identifier(s) associated with rendering context stored in the table enable the manager to divide computing and rendering calls among multiple threads.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

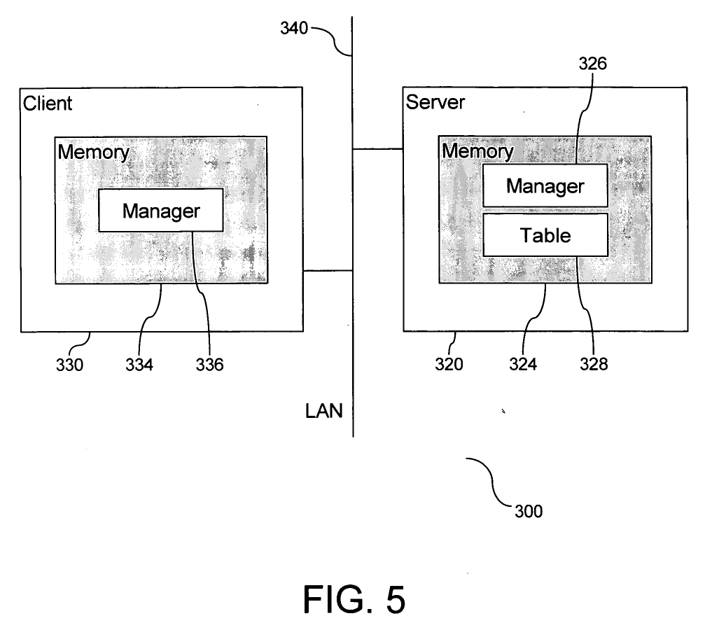

In one embodiment, the manager may be implemented in software, which includes but is not limited to firmware, resident software, microcode, etc. The software implementation can take the form of a computer program product accessible from a computer-useable or computer-readable medium providing program code for use by or in connection with a computer or any instruction execution system. FIG. 5 is a block diagram (300) illustrating the manager in a client-server environment. As shown, both a server (320) and a client (330) includes memory (324) and (334), respectively. The server memory (324) includes a manager (326) embedded therein, and the client memory (334) includes a manager (336) embedded therein. The table (328) and the rendering context stored therein are stored within memory (324) of the server (320). The client manager (336) communicates with the server manager (326) across the network (340) to query the server manager (326) for rendering context and to invoke an OpenGL32 command to an OpenGL32 library. For the purposes of this description, a computer-useable or computer-readable medium can be any apparatus that can contain, store, communicate, propagate, or transport the program for use by or in connection with the instruction execution system, apparatus, or device.

### Advantages Over The Prior Art

Implementation of the manager for rendering context in conjunction with OpenGL32 commands divides computing and rendering actual OpenGL32 calls among multiple threads in a single process. All rendering-context-related calls to the OpenGL32 library are processed through the manager. A thread passing an identifier associated with stored rendering context is passed directly to the OpenGL32 library as the manager owns the context resource. Similarly, for an OpenGL32 command without an identifier, the manager processes the OpenGL32 command to create the rendering context to support the command. The process of dividing these two tasks enables the manager to support processing multiple threads in a single process requesting issuance of an OpenGL32 command.

### ALTERNATIVE EMBODIMENTS

It will be appreciated that, although specific embodiments of the invention have been described herein for purposes of illustration, various modifications may be made without departing from the spirit and scope of the invention. In particular, in a single process environment, the virtual OpenGL32 command to the manager may be invoked through shared memory, sockets, signal events, or remote procedure calls. Furthermore, implementation of the manager can be as a thread or a dynamically linked library in a single processed environment, or a separate process to support a multi-processed environment. Accordingly, the scope of protection of this invention is limited only by the following claims and their equivalents.

We claim:

1. A method for managing multithreaded requests for rendering context comprising:
receiving an OpenGL32 command from a requesting thread for rendering context;
searching a table for said rendering context to serve said command responsive to receipt of an identifier, associated with said rendering context, with said virtual command; and
forwarding said command with said rendering context to a library responsive to presence of said rendering context in said table.

2. The method of claim 1, further comprising creating said rendering context and saving said rendering context in said table responsive to absence of said rendering context in said table to serve said command.

3. The method of claim 2, further comprising creating an identifier corresponding to said created rendering context and returning said identifier to a requesting thread.

4. The method of claim 1, wherein the step of receiving an OpenGL32 command for rendering context from a requesting thread includes passing an identifier as a parameter of said virtual command.

5. The method of claim 1, wherein said table is adapted to store rendering context.

6. The method of claim 1, further comprising invoking an inter-thread communication tool for managing sending of said OpenGL32 command, wherein said tool is selected from a group consisting of: shared memory, a socket, a signal event, and a remote procedure call.

7. A computer system comprising:
a context thread manager adapted to receive an OpenGL32 command from a thread in a multi-threaded process;
a table in communication with said manager adapted to store rendering context associated with an identifier; and
said manager adapted to forward said OpenGL32 command with said rendering context to a library in response to presence of said rendering context in said table.

8. The system of claim 7, wherein said manager is adapted to create and store rendering context in said table in response to absence of stored context to serve said OpenGL32 command.

9. The system of claim 8, wherein said manager is adapted to create an identifier for said created context and to return said identifier to said calling thread.

10. The system of claim 7, further comprising said identifier as a required parameter of said OpenGL32 command.

11. The system of claim 7, wherein said table is adapted to store rendering context.

12. The system of claim 7, further comprising a tool to manage inter-thread communication associated with said OpenGL32 command, wherein said tool is selected from a group consisting of: shared memory, a socket, a signal event, and a remote procedure call.

13. An article comprising:
a computer-readable medium;
means in the medium for receiving an OpenGL32 command from a requesting thread for rendering context;
means in the medium for storing said rendering context to serve said virtual command responsive to receipt of an identifier, associated with said rendering context, with said command; and
means in the medium for forwarding said command with said rendering context to a library responsive to presence of said rendering context in said storage medium.

14. The article of claim 13, wherein the medium is a recordable data storage medium.

15. The article of claim 13, further comprising means in the medium for creating said rendering context and storing said rendering context in said medium responsive to absence of said rendering context in said storage medium.

16. The article of claim 15, further comprising means in the medium for creating an identifier corresponding to said created rendering context and returning said identifier to a requesting thread.

17. The article of claim 13, wherein said means for receiving a command for rendering context from a requesting thread passing an identifier as a parameter of said command.

18. The article of claim 13 wherein said means for storing rendering context is a hash table.

19. The article of claim 13, further comprising means in the medium for managing inter-thread communication associated with said OpenGL32 command, wherein said means is selected from a group consisting of: shared memory, a socket, a signal event, and a remote procedure call.
